(19) United States
(12) Patent Application Publication
(10) Pub. No.: US 2024/0032718 A1
(43) Pub. Date: Feb. 1, 2024

(54) Produce Core Extraction Device And Method

(71) Applicant: Cheryl Bradley, Bronx, NY (US)

(72) Inventor: Cheryl Bradley, Bronx, NY (US)

(21) Appl. No.: 17/873,938

(22) Filed: Jul. 26, 2022

(51) Int. Cl. A47J 25/00; A23N 4/12

(52) U.S. Cl. CPC A47J 25/00; A23N 4/12

(57) ABSTRACT

A produce core extraction device and method for interchanging the extractor of the device includes a handle having a cylindrical shaped body. The handle has a first end and a second end. Additionally, the handle has an exterior surface and an interior surface wherein the interior surface encloses an interior defining a space for a lever to be positioned within. An extractor is positioned on the second end of the handle. The extractor has a first end and a second end. The first end of the extractor is configured for engaging by threading to the second end of the handle. Furthermore, the second end of the extractor has a plurality of teeth for facilitating in inserting the second end of the extractor a produce.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to produce core removing device and more particularly pertains to a new produce core removing device for interchanging the extractor of the device.

### (2) Description of Related Art including information disclosed under 37 CFR 1.97 and 1.98

The prior art relates to produce core removing devices. The prior art includes a variety of produce core removing devices configured for being inserted into a produce and collecting the core of the produce. Known prior art lacks a produce core removing device configured for interchanging a variety of extractor sizes to accommodate a variety of produce sizes.

### BRIEF SUMMARY OF THE INVENTION

An embodiment of the disclosure meets the needs presented above by generally comprising a handle having a cylindrical shaped body. The handle has a first end and a second end. Additionally, the handle has an exterior surface and an interior surface wherein the interior surface encloses an interior defining a space for a lever to be positioned within. The lever has a first end and a second end. The first end of the lever has a button being configured for pushing the second end of the lever within the interior of the handle. An extractor is positioned on the second end of the handle. The extractor has a first end and a second end. In addition, the extractor has an exterior surface and an interior surface. The first end of the extractor is configured for engaging by threading to the second end of the handle. The interior surface of the extractor encloses a chamber defining a space for housing a rod. Furthermore, the second end of the extractor has a plurality of teeth being configured for facilitating in inserting the second end of the extractor within a variety of produce.

Another embodiment of the disclosure includes a method comprising a step of selecting an extractor for removing a core of a produce. The user engages by threading the extractor to a handle of a produce core extraction device. Subsequently, the user inserts a second end of the extractor into a center of a produce. The user removes the extractor from the produce with a core of the produce retained within a chamber of the extractor wherein a button of a first end of a lever is extended out from the handle. The user presses the button of the first end of the lever of the handle wherein discharging the core of the produce by a rod from the chamber of the extractor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a produce core extraction device and method according to an embodiment of the disclosure.

FIG. 2 is a top isometric view of an embodiment of the disclosure.

FIG. 3 is a cross-sectional view of an embodiment of the disclosure taken from FIG. 1 of Line 3-3.

FIG. 4 is an in-use view of an embodiment of the disclosure.

FIG. 5 is an exploded view of an embodiment of the disclosure.

FIG. 6 is an alternative view of an embodiment of the disclosure.

FIG. 7 is an alternative view of an embodiment of the disclosure.

### DETAILED DESCRIPTION OF THE INVENTION

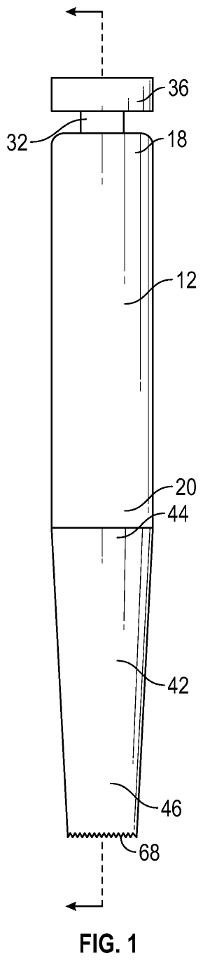

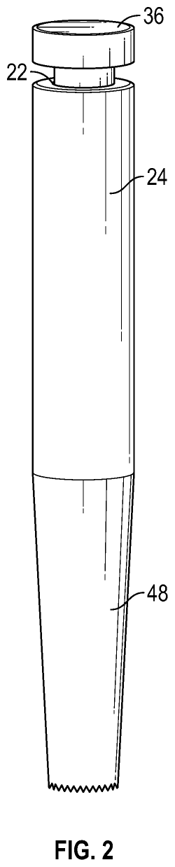

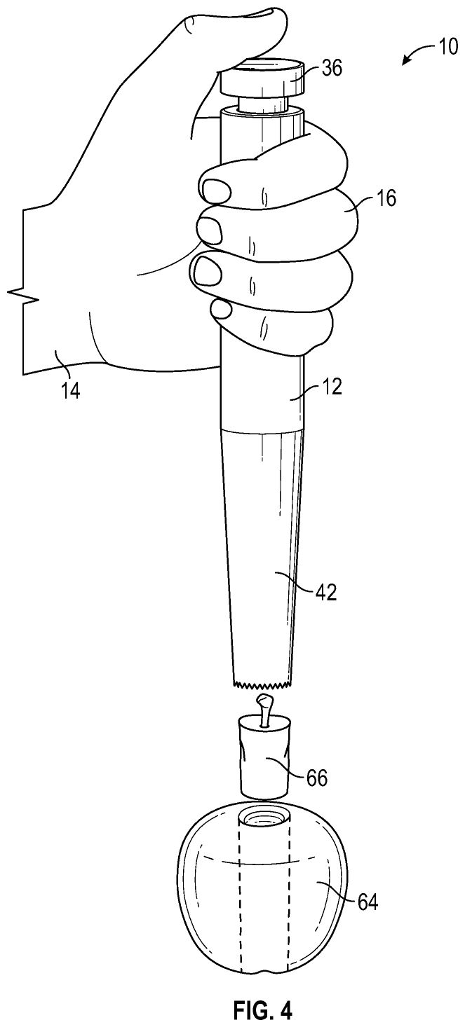

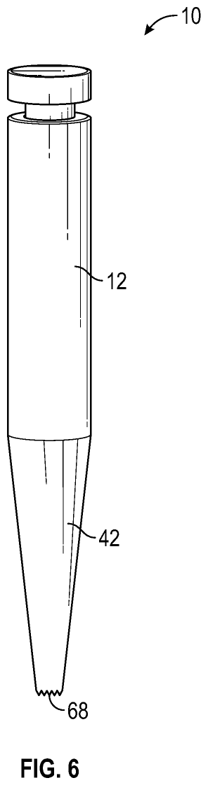

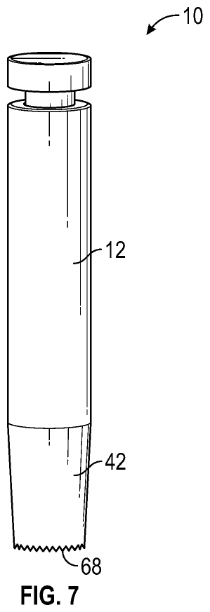

With reference now to the drawings, and in particular to FIGS. 1 through 7 thereof, a new produce core removing device embodying the principles and concepts of an embodiment of the disclosure and generally designated by the reference numeral 10 will be described.

As best illustrated in FIGS. 1 through 7, the produce core extraction device and method 10 generally comprises a handle 12. The handle 12 has a cylindrical shaped body and is configured for is enwrapped by a hand 16 of a user 14. The handle 12 has a first end 18 and a second end 20. The first end 18 of the handle 12 has a hole 22 and the second end 20 of the handle 12 is open. The handle 12 has an exterior surface 24 and an interior surface 26, and the interior surface 26 encloses an interior 28. The interior 28 defines a space for a lever 30 to be positioned within.

Furthermore, the lever 30 has a first end 32 and a second end 34. The first end 32 of the lever 30 is inserted through the hole 22 of the first end 18 of the handle 12. In addition, the first end 32 of the lever 30 has a button 36 being configured for pushing the second end 34 of the lever 30 within the interior 28 of the handle 12. Additionally, an extension spring 38 is coupled to the lever 30 and the first end 18 of the interior surface 26 of the handle 12 within the interior 28. The extension spring 38 is configured for providing spring force to the lever 30 wherein positioning the button 36 of the lever 30 towards a biased position proximate within the first end 18 the handle 12. The second end 34 of the lever 30 is positioned proximate to the second end 20 of the handle 12. A female threading 40 is positioned on the interior surface 26 of the second end 20 of the handle 12.

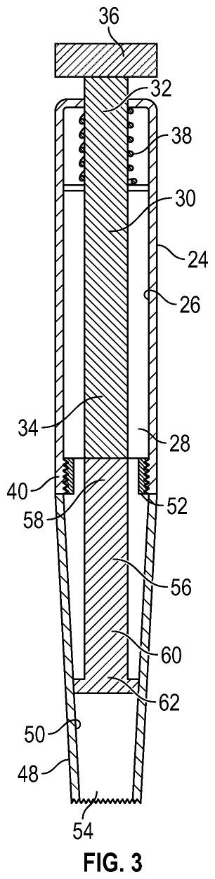

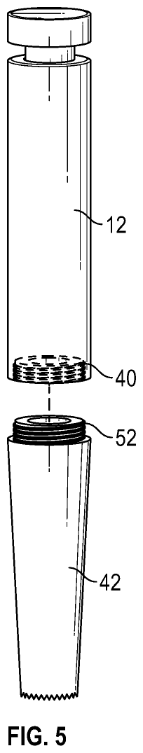

An extractor 42 is positioned on the second end 20 of the handle 12. The extractor 42 has a first end 44 and a second end 46 wherein the first end 44 and the second end 46 of the extractor 42 is open. Furthermore, the extractor 42 has an exterior surface 48 and an interior surface 50. A male threading 52 is positioned on the exterior surface 48 of the first end 44 of the extractor 42. The male threading 52 of the extractor 42 is complementary to the female threading 40 of the handle 12 thus the first end 44 of the extractor 42 is configured for engaging by threading to the second end 20 of the handle 12 as shown in FIG. 5. The interior surface 50 of the extractor 42 encloses a chamber 54. The chamber 54 defines a space for housing a rod 56. The rod 56 has a first end 58 and a second end 60, and the first end 58 of the rod 56 is positioned proximate to the first end 44 of the extractor 42. Moreover, the first end 58 of the rod 56 is configured for being positioned abutting the second end 34 of the lever 30, as shown in FIG. 3.

The second end 60 of the rod 56 has a plate 62 being configured for removing a core 66 of a produce 64 from the chamber 54 of the extractor 42. Furthermore, the second end 46 of the extractor 42 has a plurality of teeth 68 being configured for facilitating in inserting the second end 46 of the extractor 42 within a variety of produce. Each of the teeth 68 is sharpened to penetrate the exterior of the produce 64. The core 66 of the produce 64 is retained within the chamber 54 of the extractor 42 and presses against the plate 62 of the rod 56 wherein extending out the button 36 of the lever 30 from the handle 12.

In use, the user 14 selects the extractor 42 for removing the core 66 of the produce 64. The user 14 engages by threading the extractor 42 to the handle 12 of the produce core extraction device 10. Subsequently, the user 14 inserts the plurality of teeth 68 of the second end 46 of the extractor 42 into a center of the produce 64. The user 14 removes 25 the extractor 42 from the produce 64 with the core 66 of the produce 64 retained within the chamber 54 of the extractor 42 wherein the button 36 of the lever 30 is extended out from the handle 12. The user 14 presses the button 36 of the first end 32 of a lever 30 inward towards the handle 12 wherein discharging the core 66 of the produce 64 by the plate 62 of the rod 56 from the chamber 54 of the extractor 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A produce core extraction device configured for removing the core from a variety of produce items, the produce core extraction device comprising:
a handle having a cylindrical shaped body, the handle having a first end and a second end, the handle having an exterior surface and an interior surface, the interior surface enclosing an interior, the interior defining a space for a lever to be positioned within, the lever having a first end and a second end, the first end of the lever having a button, the button being configured for pushing the second end of the lever within the interior of the handle; and
an extractor being positioned on the second end of the handle, the extractor having a first end and a second end, the extractor having an exterior surface and an interior surface, the first end of the extractor being configured for engaging by threading to the second end of the handle, the interior surface of the extractor enclosing a chamber, the chamber defining a space for housing a rod, the second end of the extractor having a plurality of teeth, the plurality of teeth being configured for facilitating in inserting the second end of the extractor within a variety of produce.

2. The produce core extraction device of claim 1, further comprising the handle being configured for being enwrapped by a hand of a user.

3. The produce core extraction device of claim 1, further comprising the first end of the handle having a hole, the second end of the handle being open.

4. The produce core extraction device of claim 3, further comprising the first end of the lever being inserted through the hole of the first end of the handle.

5. The produce core extraction device of claim 4, further comprising a extension spring being coupled to the lever and the first end of the handle within the interior, the extension spring being configured for providing spring force to the lever.

6. The produce core extraction device of claim 5, further comprising the second end of the lever being positioned proximate to the second end of the handle, a female threading being positioned on the interior surface of the second end of the handle.

7. The produce core extraction device of claim 1, further comprising the first end and the second end of the extractor being open.

8. The produce core extraction device of claim 6, further a male threading being positioned on the exterior surface of the first end of the extractor, the male threading of the extractor being complementary to the female threading of the handle.

9. The produce core extraction device of claim 8, further comprising the rod having a first end and a second end, the first end of the rod being positioned proximate to the first end of the extractor, the first end of the rod being configured for being positioned abutting the second end of the lever.

10. The produce core extraction device of claim 9, further comprising the second end of the rod having a plate, the plate being configured for removing a core of a produce from the chamber of the extractor.

11. A produce core extraction device configured for removing the core from a variety of produce items, the produce core extraction device comprising:
a handle having a cylindrical shaped body, the handle being configured for being enwrapped by a hand of a user, the handle having a first end and a second end, the first end of the handle having a hole, the second end of the handle being open, the handle having an exterior surface and an interior surface, the interior surface enclosing an interior, the interior defining a space for a lever to be positioned within, the lever having a first end and a second end, the first end of the lever being inserted through the hole of the first end of the handle, the first end of the lever having a button, the button being configured for pushing the second end of the lever within the interior of the handle, a extension spring being coupled to the lever and the first end of the handle within the interior, the extension spring being configured for providing spring force to the lever, the second end of the lever being positioned proximate to the second end of the handle, a female threading being positioned on the interior surface of the second end of the handle; and
an extractor being positioned on the second end of the handle, the extractor having a first end and a second end, the first end and the second end of the extractor being open, the extractor having an exterior surface and an interior surface, a male threading being positioned on the exterior surface of the first end of the extractor, the male threading of the extractor being complementary to the female threading of the handle, the first end of the extractor being configured for engaging by threading to the second end of the handle, the interior surface of the extractor enclosing a chamber, the chamber defining a space for housing a rod, the rod having a first end and a second end, the first end of the rod being positioned proximate to the first end of the extractor, the first end of the rod being configured for being positioned abutting the second end of the lever, the second end of the rod having a plate, the plate being configured for removing a core of a produce from the chamber of the extractor, the second end of the extractor having a plurality of teeth, the plurality of teeth being configured for facilitating in inserting the second end of the extractor within a variety of produce.

12. A method for extracting a core from a produce, the method comprising a step of:
selecting an extractor for removing a core of a produce;
engaging by threading the extractor to a handle of a produce core extraction device;
inserting a second end of the extractor into a center of a produce;
removing the extractor from the produce with a core of the produce retained within a chamber of the extractor wherein a button of a first end of a lever is extended out from the handle; and
pressing the button of the first end of the lever of the handle wherein discharging the core of the produce by a rod from the chamber of the extractor.
